(19) United States
(12) Patent Application Publication
(10) Pub. No.: US 2026/0035940 A1
(43) Pub. Date: Feb. 5, 2026

(54) DEMOLITION GUARD

(71) Applicant: Edward Thomas Haley, Muncie, IN (US)

(72) Inventor: Edward Thomas Haley, Muncie, IN (US)

(21) Appl. No.: 19/357,405

(22) Filed: Oct. 14, 2025

Related U.S. Application Data
(63) Continuation-in-part of application No. 18/304,863, filed on Apr. 21, 2023, now abandoned.

(51) Int. Cl. E04G 21/24; A01G 13/20

(52) U.S. Cl. CPC E04G 21/24; A01G 13/20

(57) ABSTRACT

A guard for protecting an object that include front and rear panel assemblies that each include a panel, a top panel that covers a gap between the front and rear panel assemblies, a hinge pin that rotatably couples the front and rear panel assemblies about an axis of rotation such that the front and rear panel assemblies are rotatable between an angle of rotation between approximately 0 degrees to at least 45 degrees, where the guard is adapted to protect the object from a falling mass that is at least 240 pounds failing from 20 feet directly above the object.

### CROSS-REFERENCE TO RELATED APPLICATIONS

This application is a continuation-in-part of U.S. patent application Ser. No. 18/304,863 filed Apr. 21, 2023, which is hereby incorporated by reference.

### BACKGROUND

The present disclosure relates to a protective guard for use during demolition and construction.

There is a risk for objects to accidentally fall or be dropped from substantial heights during construction, roofing, or other outdoor maintenance activities. For example, building and/or roofing materials fall from a roof that is multiple stories above ground. The impact of such falling objects can be severe and has the potential to cause significant damages. Outdoor furnishings, appliances, and/or other objects are at risk to be damaged or destroyed by such impacts.

There is a need for protecting objects that cannot be moved during construction. This can be accomplished through a combination of several design features described below.

### BRIEF DESCRIPTION OF THE DRAWINGS

FIG. 1 is a perspective view of a guard that is positioned to protect an object.

FIG. 2 is a side elevation view of the FIG. 1 guard and object.

FIG. 3 is a perspective view of the FIG. 1 guard in a closed and collapsed configuration.

FIG. 4 is a bottom plan view of the FIG. 3 guard.

FIG. 5 is a perspective view of the FIG. 1 guard in an open and collapsed configuration.

FIG. 6 is a perspective view of the FIG. 1 guard in an open and extended configuration.

FIG. 7 is a perspective view of an intermediate panel assembly.

FIG. 8 is a perspective view of an intermediate pin.

FIG. 9 is a perspective view of a guard assembly including the FIG. 1 guard and the FIG. 7 intermediate panel assembly.

FIG. 10 is a perspective view of another embodiment of a guard assembly including the FIG. 1 guard and the FIG. 7 intermediate panel assembly.

FIG. 11 is a perspective view of yet another embodiment of a guard assembly including the FIG. 1 guard and the FIG. 8 intermediate pin.

FIG. 12 is a perspective view of a hood and a barrier accessory for a ladder.

FIG. 13 is a perspective view of an alternative embodiment of a guard incorporating elements of the FIG. 1 guard.

FIG. 14 is a front elevation view of the FIG. 13 guard.

FIG. 15 is a perspective view of a sheet, a component of the FIG. 13 guard.

FIG. 16 is an enlarged perspective view of the FIG. 13 guard in a closed configuration.

FIG. 17 is an enlarged perspective view of the FIG. 13 guard in an open configuration.

### DESCRIPTION OF THE SELECTED EMBODIMENTS

For the purpose of promoting an understanding of the principles of the claimed invention, reference will now be made to the embodiments illustrated in the drawings and specific language will be used to describe the same. It will nevertheless be understood that no limitation of the scope of the claimed invention is thereby intended. Any alterations and further modifications in the described embodiments, and any further applications of the principles of the claimed invention as described herein are contemplated as would normally occur to one skilled in the art to which the claimed invention relates. One embodiment of the claimed invention is shown in great detail, although it will be apparent to those skilled in the relevant art that some features that are not relevant to the present claimed invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “left”, “right”, “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

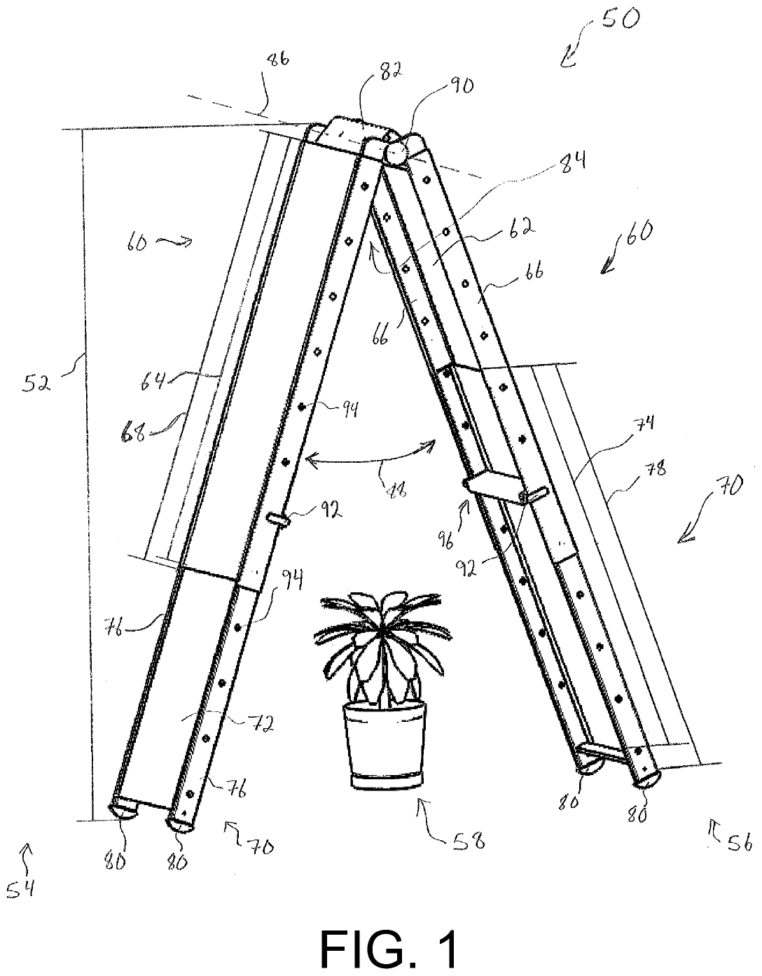

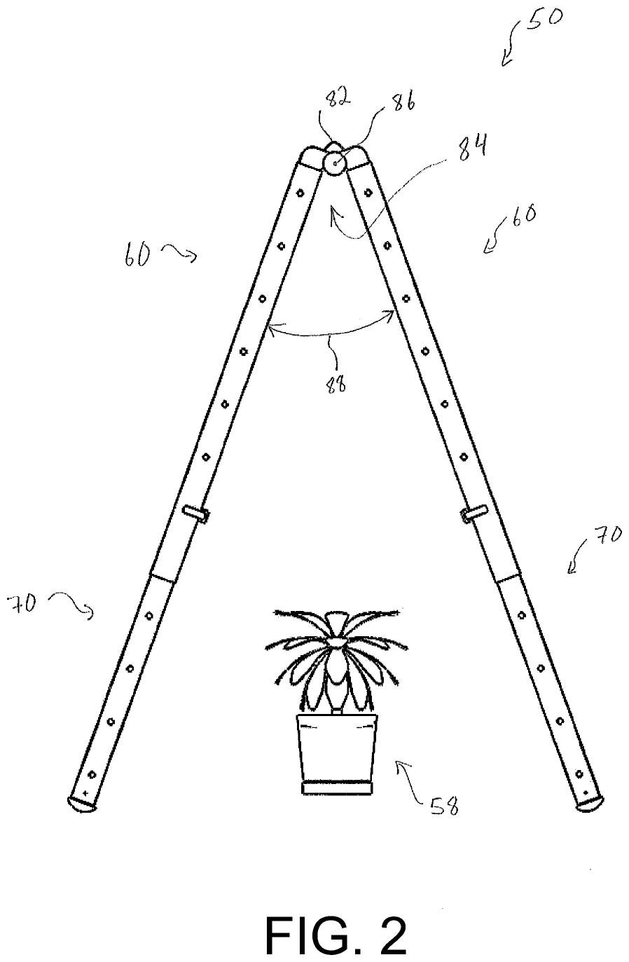

Referring to FIG. 1 and FIG. 2, guard 50 is positioned to protect an object 58 from items falling from above. Guard 50 shields object 58 in a vertical direction from objects that may fall. Such falling objects first contact the guard which deflects them away from object 58. Particularly, guard 50 is configured to protect object 58 from debris or building materials that may fall during installation or removal of roofing systems. For example, guard 50 may protect against shingles, rafters, ridge boards, flashing, gutters, insulation, and/or other similar materials. Guard 50 is rigid in construction such that when one or more objects fall onto guard 50, guard 50 is configured to withstand considerable impact. In one embodiment, guard 50 is configured to withstand the impact of a square of roofing shingles falling from twenty feet. In another embodiment, guard 50 is configured to withstand the impact of one or more objects whose weight exceeds 240 pounds and which are falling from twenty feet above guard 50.

The position and arrangement of guard 50 can adjust to protect different types of objects 58. For example, the guard may adjust to cover air conditioning units, plants, planters, statues, pipes, and/or other objects.

Guard 50 generally includes two upper panel assemblies 60, two lower panel assemblies 70, and top plate 82. One upper panel assembly 60 and one lower panel assembly 70 are positioned on front side 54 of guard 50, and one upper panel assembly 60 and one lower panel assembly 70 are positioned on rear side 56 of guard 50. The upper panel assemblies 60 and lower panel assemblies 70 provide structural support for guard 50 such that guard 50 can stand upright. Upper panel assemblies 60 define space 84 between each other. Top plate 82 is positioned on an upper portion of guard 50 such that top plate 82 extends across space 84. As shown, upper panel assemblies 60 and lower panel assemblies 70 shield object 58 in a vertical direction on front side 54 and rear side 56, and top plate 82 shields object 58 in a vertical direction between upper panel assemblies 60.

Upper panel assemblies 60 each generally include an upper panel 62 and two upper legs 66. Upper panel 62 extends between upper legs 66 and is generally rectangular in shape. Upper panel 62 generally extends from a terminal end of upper legs 66 on the top side of guard 50. Upper panel 62 generally extends along a majority of upper legs 66. In one embodiment, upper legs 66 are positioned along the longer sides of upper panel 62. In the shown embodiment, upper legs 66 are positioned on an interior-facing side of upper panel 62. Upper legs 66 may be distinct parts coupled to upper panel 62. For example, upper legs 66 can be coupled to upper panel 62 using one or more screws, bolts, rivets, nails, adhesives, welds, and/or other fasteners. In an alternative embodiment, upper panel assembly 60 can be unitarily constructed from a single piece of material.

Similarly, lower panel assemblies 70 each generally include lower panel 72 and two lower legs 76. Lower panel 72 extends between lower legs 76 and is generally rectangular in shape. Lower panel 72 can extend from a terminal end of lower legs 76 and along a majority of lower legs 76. In one embodiment, lower legs 76 are positioned along the longer sides of lower panel 72. In the shown embodiment, lower legs 76 are positioned on an interior-facing side of lower panel 72. Lower legs 76 may be distinct parts coupled to lower panel 72. For example, lower legs 76 can be coupled to lower panel 72 using one or more screws, bolts, rivets, nails, adhesives, welds, and/or other fasteners. In an alternative embodiment, lower panel assembly 70 can be unitarily constructed from a single piece of material.

Lower panel assemblies 70 further include feet 80 that are positioned on lower portions of lower legs 76. Feet 80 provide stability for guard 50 when positioned on various ground surfaces. Feet 80 may be distinct parts coupled to lower legs 76. For example, feet 80 can couple to lower legs 76 using one or more screws, bolts, rivets, nails, adhesives, welds, and/or other fasteners. In one embodiment, feet 80 are made from rubber or another non-slip material. Feet 80 may be made from a material that is more flexible than the material of upper panel assemblies 60 and lower panel assemblies 70. In one embodiment, a lower surface of feet 80 is rounded such that the ground is tangent to the lower surface. In another embodiment, a lower surface of feet 80 has ridges which provide stability on loose ground, such as sand or dirt.

Upper panel assemblies 60 and lower panel assemblies 70 can be made from rigid materials that substantially resist deformation and withstand impacts. In one embodiment, upper panels 62 are made of the same material as upper legs 66, and lower panels 72 are made of the same material as lower legs 76. For example, all of one upper panel assembly 60 can be made of aluminum, and all of one lower panel assembly 70 can be made of aluminum. In an alternate embodiment, one or more parts of upper panel assemblies 60 and lower panel assemblies 70 can be made from a different metal, fiberglass, plastic, wood, and/or another rigid material. Additionally, the material composition of upper panel assemblies 60 and lower panel assemblies 70 in guard 50 may vary. For example, at least one of upper panel assemblies 60 and lower panel assemblies 70 is made of aluminum, and at least one of upper panel assemblies 60 and lower panel assemblies 70 is made of a different material. Alternatively, upper panel assemblies 60 and lower panel assemblies 70 can all be made of the same material.

Upper panel assemblies 60 are rotationally coupled to one another around an axis of rotation 86. Upper panel assembly 60 on front side 54 is selectively rotatable relative to top plate 82. Similarly, upper panel assembly 60 on rear side 56 is selectively rotatable relative to top plate 82. Upper panel assemblies 60 define an angle of rotation 88 with respect to axis of rotation 86. Guard 50 can be placed in multiple configurations by varying angle of rotation 88. In one embodiment, guard 50 is in a closed configuration when angle of rotation 88 is below a threshold. The threshold is typically close to 0 degrees. In one example, guard 50 is in a closed configuration when angle of rotation 88 is below 5 degrees. In another example, guard 50 is in a closed configuration when angle of rotation 88 is 0 degrees. In an additional embodiment, guard 50 is in an open configuration when angle of rotation 88 is greater than the threshold of the closed configuration. Alternatively, the threshold may not determine whether guard 50 is in an open configuration. As examples, guard 50 is open when angle of rotation 88 is at a maximum value and/or when angle of rotation 88 is sufficient such that object 58 can be placed under guard 50.

Guard 50 is in a fully open configuration when angle of rotation 88 is at an upper limit. In one embodiment, upper panel assemblies 60 rotate relative to one another such that angle of rotation 88 does not exceed 45 degrees. In another embodiment, angle of rotation 88 does not exceed 180 degrees. In yet another embodiment, angle of rotation 88 does not exceed a value between 45 and 180 degrees. The maximum of angle of rotation 88 may be determined by the coupling between upper panel assemblies 60 and top plate 82. As examples, top plate 82 contacts upper panel assemblies 60, or upper panel assemblies 60 contact one another, at the maximum angle which prevents upper panel assemblies 60 from rotating further. Alternatively, guard 50 may include a stopping mechanism.

The rotational motion of upper panel assemblies 60 is selectable such that the positions of upper panel assemblies 60 may be fixed relative to one another at a desired angle of rotation 88. Guard 50 includes one or more latches, pins, buttons, locks, bolts, fasteners, clamps, frictional elements, and/or other mechanisms to selectively fix angle of rotation 88 between upper panel assemblies 60. For example, guard 50 includes a lock that can be pushed, pulled, or slid into and out of a position to fix angle of rotation 88. In one embodiment, angle of rotation 88 is selectively fixed in discrete increments. For example, angle of rotation 88 is selectable in increments of 5, 10, or 15 degrees. In an alternative embodiment, angle of rotation 88 is continuously selectable through the full range of rotation. In yet another embodiment, guard 50 is configured to fix angle of rotation 88 unless a user selectively rotates upper panel assemblies 60 that prevents upper panel assemblies 60 from rotating past a maximum angle.

Guard 50 further includes a mechanism for rotationally coupling upper panel assemblies 60 along axis of rotation 86. For example, upper panel assemblies 60 are rotationally coupled through one or more pins, hinges, axles, or other means of rotation. In the illustrated embodiment, upper panel assemblies 60 are rotationally coupled using hinge pins 90. One hinge pin 90 couples to the right side and one hinge pin 90 couples to the left side of upper panel assemblies 60. In an alternate embodiment, one hinge pin 90 couples to both the right and left sides of both upper panel assemblies 60. Hinge pins 90 can allow a user to selectively rotate upper panel assemblies 60. In one example, hinge pins 90 are movable between an open and a locked position. When hinge pins 90 are open, such as pushed inward toward the interior of guard 50, upper panel assemblies 60 can rotate relative to one another and/or relative to top plate 82. When hinge pins 90 are in the locked position, hinge pins 90 lock upper panel assemblies 60 relative to one another to fix upper panel assemblies 60 at a desired angle of rotation 88. In this way, hinge pins 90 support selective rotation of upper panel assemblies 60 to selectively adjust guard 50.

Top plate 82 couples to an upper portion of guard 50 to cover space 84. In the illustrated embodiment, top plate 82 couples to guard 50 at axis of rotation 86. In another embodiment, top plate 82 couples to another portion of guard 50. Top plate 82 may rotate when there is a change in angle of rotation 88. In one example, top plate 82 is independently rotatable relative to upper panel assemblies 60 on front side 54 and rear side 56. Top plate 82 resists deformation and is made of a rigid material, for example rolled aluminum. In one embodiment, top plate 82 is made of the same material as upper panel assemblies 60 and/or lower panel assemblies 70. Top plate 82 can be a unitary structure that extends between hinges pins 90 on the lateral sides of guard 50.

Guard 50 defines a guard height 52. Each upper panel 62 defines an upper panel height 64, and upper legs 66 defines an upper leg height 68 on each upper panel assembly 60. Further, each lower panel 72 defines a lower panel height 74, and lower legs 76 defines a lower leg height 78 on each lower panel assembly 70. In the illustrated embodiment, each upper panel assembly 60 defines the same upper panel height 64 and upper leg height 68, and each lower panel assembly 70 defines the same lower panel height 74 and lower leg height 78. Upper leg height 68 may differ from upper panel height 64. Similarly, lower leg height 78 may differ from lower panel height 74. For example, upper leg height 68 may be greater than upper panel height 64 on upper panel assembly 60, and/or lower leg height 78 may be greater than lower panel height 74 on lower panel assembly 70. Upper legs 66 may extend below and/or above upper panel 62 in an upper panel assembly 60, and lower legs 76 may extend below and/or above lower panel 72 in a lower panel assembly 70. Upper panel height 64 generally extends across a majority of upper leg height 68. Similarly, lower panel height 74 generally extends across a majority of lower leg height 78. Further, upper panel height 64 may differ from lower panel height 74, and/or upper leg height 68 may differ from lower leg height 78.

At least one upper panel assembly 60 is positioned at least partially within a lower panel assembly 70, and/or at least one lower panel assembly 70 is positioned at least partially within an upper panel assembly 60. In the illustrated embodiment, both lower panel assemblies 70 are positioned within upper panel assemblies 60. Each upper panel assembly 60 is movably coupled to a lower panel assembly 70 such that upper panel assembly 60 slides relative to lower panel assembly 70 in a direction along upper panel height 64. Guard 50 is in an extended configuration when at least one upper panel assembly 60 has been slid along a coupled lower panel assembly 70 such that guard height 52 increases relative to a collapsed configuration. Guard 50 is fully extended when upper panel assemblies 60 have slid along coupled lower panel assemblies 70 to the fullest extent.

Guard 50 is in a collapsed configuration when at least one of front side 54 and rear side 56 are collapsed. In one embodiment, guard 50 is in a collapsed configuration when both front side 54 and rear side 56 are collapsed. One side of guard 50 is in a collapsed configuration when a lower panel assembly 70 is positioned within an upper panel assembly 60 to the fullest extent. In one embodiment, lower panel assembly 70 is fully nested within upper panel assembly 60 when one side of guard 50 is collapsed. In another embodiment, only some parts of lower panel assembly 70 are fully nested inside upper panel assembly 60. For example, lower legs 76 of a lower panel assembly 70 are fully nested within upper legs 66 of an upper panel assembly 60 and/or lower panel 72 of a lower panel assembly 70 is fully nested within an upper panel assembly 60 when guard 50 is in a collapsed configuration. In yet another embodiment, a portion of guard 50 contacts one of upper panel assembly 60 and lower panel assembly 70 and prevents lower panel assembly 70 from sliding further into upper panel assembly 60.

In the illustrated embodiment, lower legs 76 of a lower panel assembly 70 are positioned in interior portions of upper legs 66 of an upper panel assembly 60 that is movably coupled to lower panel assembly 70. Upper legs 66 are hollow such that an interior portion defines a channel to house lower legs 76. In an alternative embodiment, lower legs 76 are hollow and upper legs 66 are positioned within lower legs 76. Upper legs 66 are formed from sheets of rigid material, such that upper legs 66 maintain strength and stability while providing a hollow interior. For example, upper legs 66 can be formed from C-channel bars, U-channel bars, rectangular tube bars, or another type of hollow beam. In an alternate embodiment, upper legs 66 are formed by cutting or milling a channel into a solid piece of rigid material. Lower legs 76 may be formed similarly to the upper legs 66 or may be formed from a solid piece of rigid material.

The sliding movement of upper panel assemblies 60 and lower panel assemblies 70 is selectable such that upper panel assemblies 60 can be fixed in position relative to lower panel assemblies 70. Guard 50 may include one or more latches, pins, buttons, locks, bolts, fasteners, clamps, frictional elements, and/or other mechanisms to selectively fix the position of an upper panel assembly 60 relative to a lower panel assembly 70. In one embodiment, the movement of an upper panel assembly 60 relative to a lower panel assembly 70 is selectable in discrete increments along upper leg height 68. For example, the relative position of an upper panel assembly 60 can be selected from eight evenly spaced increments along upper leg height 68. In an alternative embodiment, the position of an upper panel assembly 60 relative to a lower panel assembly 70 is continuously selectable along upper leg height 68. In yet another embodiment, guard 50 is configured to fix the position of upper panel assemblies 60 relative to lower panel assemblies 70 unless a user attempts to slide an upper panel assembly 60 along a lower panel assembly 70.

In the shown embodiment, guard height 52 is selectable using one or more height setting pins 92 which are selectively coupled to one or more pin openings 94. Upper legs 66 and/or lower legs 76 define pin openings 94. In one embodiment, each upper leg 66 defines multiple pin openings 94 dispersed along upper leg height 68, and each lower leg 76 defines multiple pin openings 94 dispersed along lower leg height 78. Pin openings 94 may be dispersed in discrete intervals. For example, upper leg 66 defines eight evenly spaced openings along the leg height 68. In one embodiment, pin openings 94 extend through upper legs 66 and/or lower legs 76 from an exterior portion to an interior portion. In an alternate embodiment, pin openings 94 extend only partially through upper legs 66 and/or lower legs 76.

When one upper panel assembly 60 slides along one lower panel assembly 70, at least one height setting pin 92 is inserted into at least one pin opening 94 to fix upper panel assembly 60 in place relative to lower panel assembly 70. Height setting pins 92 are adapted to simultaneously extend into an opening 94 on upper panel assembly 60 and an opening on lower panel assembly 70. In one embodiment, one height setting pin 92 couples to a pin opening 94 on an upper leg 66 and a pin opening 94 on a lower leg 76. In another embodiment, one height setting pin 92 couples to only one pin opening 94 on one upper leg 66 or on one lower leg 76. For example, a height setting pin 92 can be movably coupled to a lower panel assembly 70 and can couple to a pin opening 94 on upper leg 66 of an upper panel assembly 60.

The position of upper panel assemblies 60 relative to lower panel assemblies 70 can be set independently on front side 54 and rear side 56 of guard 50. In one embodiment, upper panel assemblies 60 are positioned relative to lower panel assemblies 70 in the same way on front side 54 and rear side 56. In an alternate embodiment, upper panel assembly 60 is positioned at a different height along lower panel 70 on front side 54 than upper panel assembly 60 and lower panel assembly 70 on rear side 56. For example, guard 50 can be placed on a sloped surface and the position of upper panel assembly 60 can be raised or lowered along lower panel assembly 70 on one side to compensate for the slope.

Guard 50 optionally includes a pin receptacle 96 that couples to height setting pins 92. Pin receptacle 96 keeps height setting pins 92 attached to guard 50 when height setting pins 92 are removed from pin openings 94. Height setting pins 92 are U-shaped where one end couples to pin openings 94 and the other end couples to pin receptacle 96. Height setting pins 92 are free to rotate around the end of height setting pin 92 attached to pin receptacle 96. For example, a height setting pin 92 is removed from a pin receptacle 96 and is rotated away from pin opening 94. In one embodiment, pin receptacle 96 is biased to pull height setting pins 92 in an inward direction such that height setting pins 92 are held in a coupled position within pin openings 94.

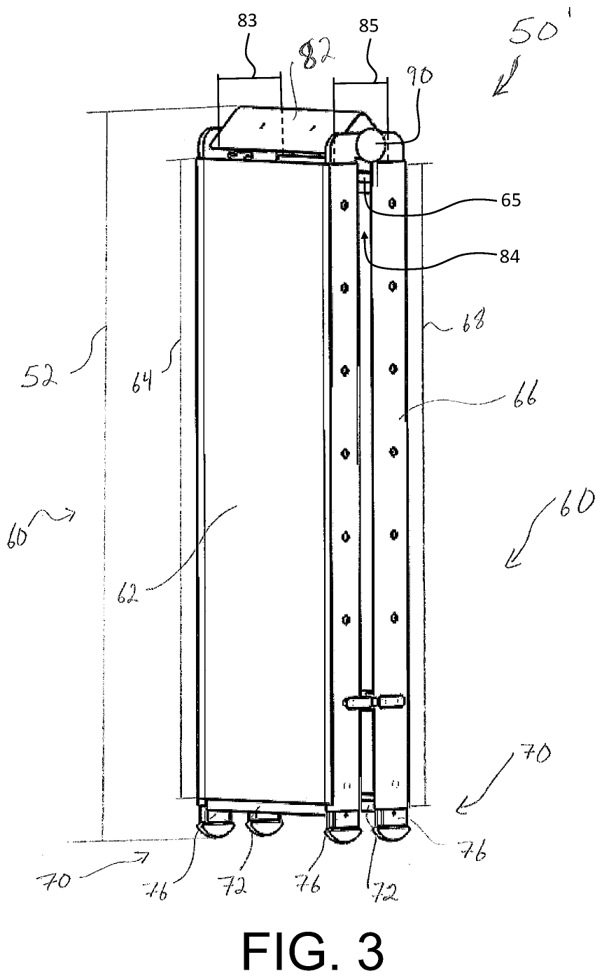

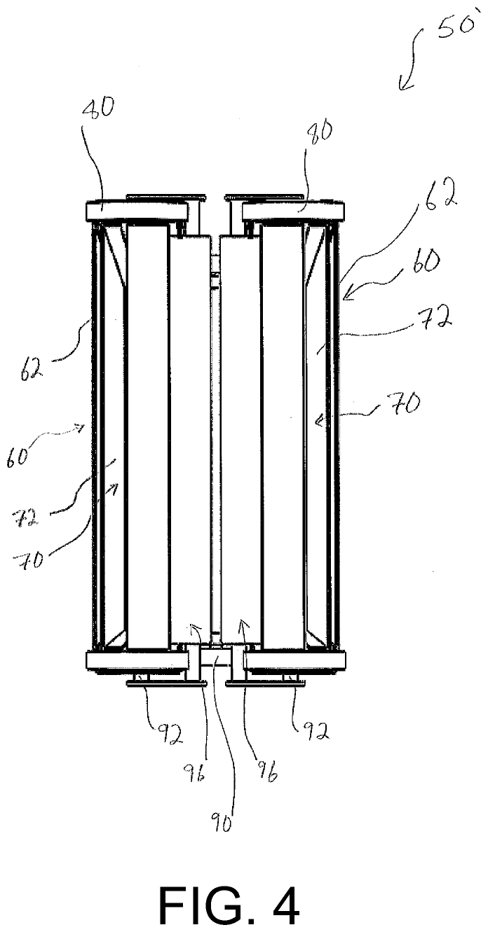

Referring to FIG. 3 and FIG. 4, guard 50′ can be placed in a closed and collapsed configuration. In the illustrated embodiment, angle of rotation 88 is zero (0) degrees. Additionally, lower panel assemblies 70 are fully nested within upper panels 60 in the illustrated embodiment of guard 50′. Guard 50′ may be arranged in a closed and collapsed configuration to be stored when not being used to protect object 58.

As shown in FIG. 3, top plate 82 defines a plate width 83. Plate width 83 can be defined as the horizontal width of top plate 82 when viewed vertically from above. Similarly, guard 50′ can define a gap width 85 between upper panel assemblies 60 on either side. Gap width 85 is generally the distance between upper panel assemblies 60 across space 84. In one example, gap width 85 can be defined between upper edges on panels 62. In another example, upper panel assembly 60 can include an upper stud 65. Upper stud 65 can strengthen upper panel assembly 60 on a top side. Specifically, upper stud 65 can span between upper legs 66 to bolster upper panel assembly 60. Further upper stud 65 can extend further into space 84 than upper panel 62. In this example, gap width 85 can be defined between upper studs 65 on upper panel assemblies 60. Gap width 85 can be the horizontal distance between upper panel assemblies 60 when viewed vertically from above.

As noted, if left uncovered, space 84 can allow debris and/or other objects to fall between upper panel assemblies 60. Top plate 82 covers space 84 to ensure that object 58 is protected from a vertical direction despite space 84 between upper panel assemblies 60. Plate width 83 is larger than gap width 85. By having a larger plate width 83 than gap width 85, top plate 82 can fully span space 84 between upper panel assemblies 60 in a horizontal direction. Therefore, top plate 82 can form a continuous barrier with panel assemblies 60 to protect against falling debris and other objects. Further, top plate 82 can span space 84 in all orientations and arrangements of guard 50′. For instance, in the FIG. 3 example, top plate 82 spans fully across gap width 85 when guard 50′ is in the closed configuration. When guard 50′ is rotated out and/or tilted in different orientations, top plate 82 can continue to span gap width 85. For instance, in all orientations and configurations, plate width 83 can be larger than gap width 85.

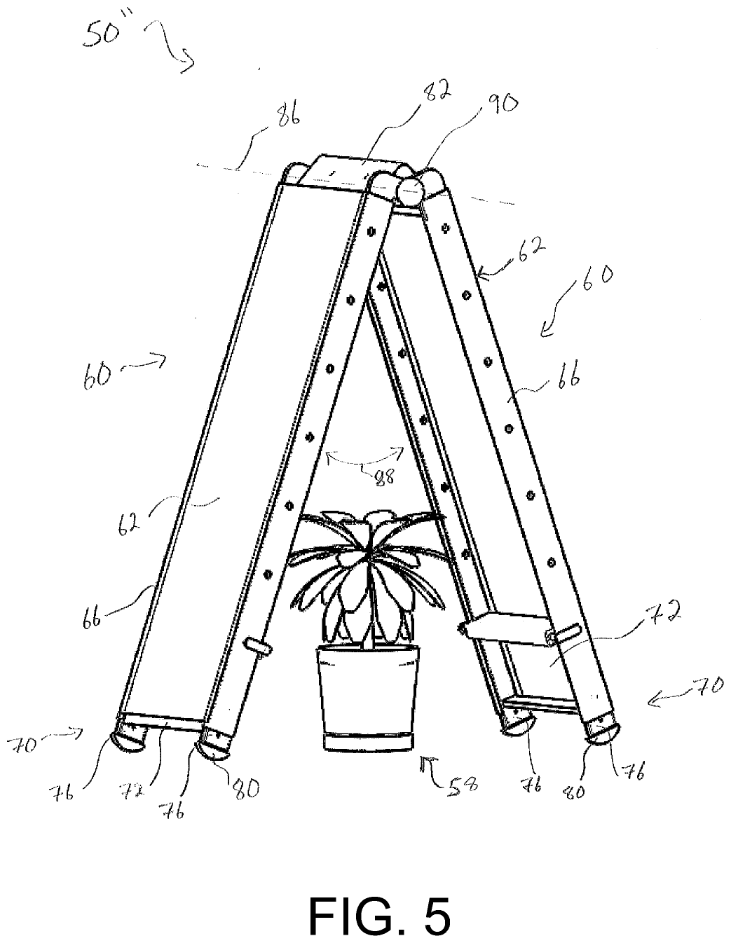

Referring to FIG. 5, guard 50″ can further be placed in a collapsed and open configuration to be positioned above object 58. As illustrated, lower panel assemblies 70 are fully nested within upper panel assemblies 60 in guard 50″. Further, guard 50″ may protect object 58 in a collapsed configuration if object 58 is small enough to fit underneath guard 50″ without extending guard height 52.

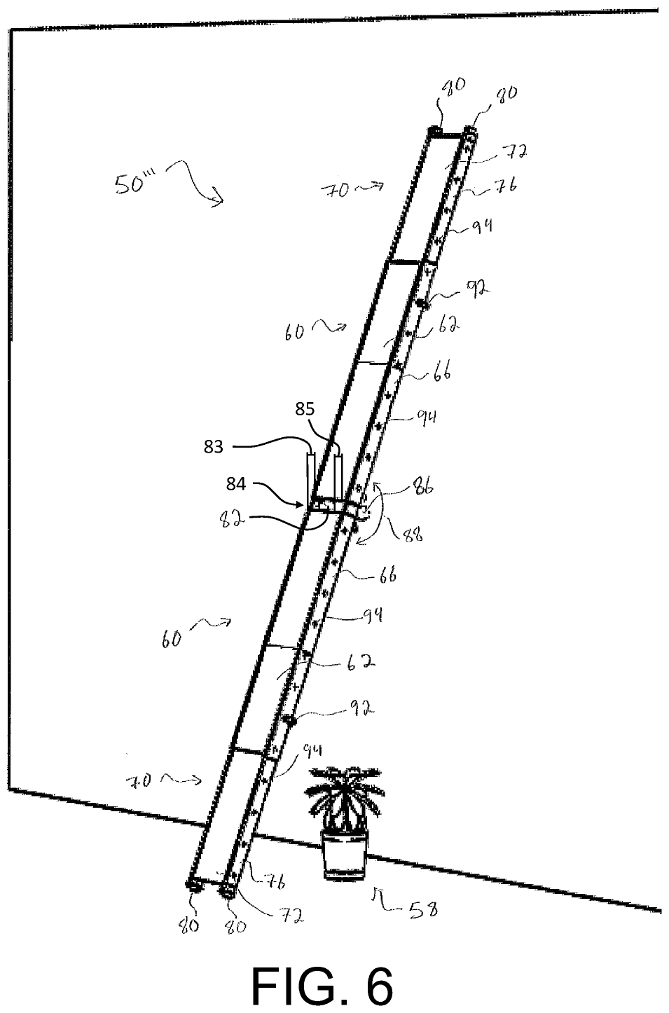

Referring to FIG. 6, guard 50′″ can be placed in a fully extended and fully open configuration. As illustrated, upper panel assemblies 60 are rotated apart such that angle of rotation 88 is 180 degrees. When guard 50 is in a fully open configuration, one pair of feet 80 are positioned on the ground and the other pair of feet 80 are positioned against a wall or another structure. Alternatively, one pair of feet 80 may not be positioned against any structure.

As illustrated, top plate 82 can span across gap width 85 when guard 50′″ is in the fully extended configuration. Further, in the FIG. 6 example, top plate 82 can fully cover gap width 85 when guard 50″ is rotated and/or tilted into different orientations. As shown, plate width 83 and gap width 85 can be defined based on horizontal distances. Plate width 83 can be larger than gap width 85 in the fully extended configuration. In other words, top plate 82 can fully span gap width 85 in this configuration to create a continuous barrier from a vertical direction. As should be understood, gap width 85 can change as guard 50′″ is tilted in different orientations. Top plate 82 can cover space 84 from a vertical direction in all orientations of guard 50″. In other words, plate width 83 can always be larger than gap width 85 regardless of the orientation and configuration of guard 50″. Further, top plate 82 can rotate to provide broader coverage across space 84. In one example, top plate 82 can rotate as guard 50″ is tilted such top plate 82 covers a consistent horizontal distance in all orientations of guard 50″. In this example, plate width 83 can remain consistent and therefore span beyond gap width 85 in all orientations of guard 50″. Even when guard 50″ is in the fully extended configuration and oriented in a horizontal direction, top plate 82 can fully cover space 84 from a vertical direction.

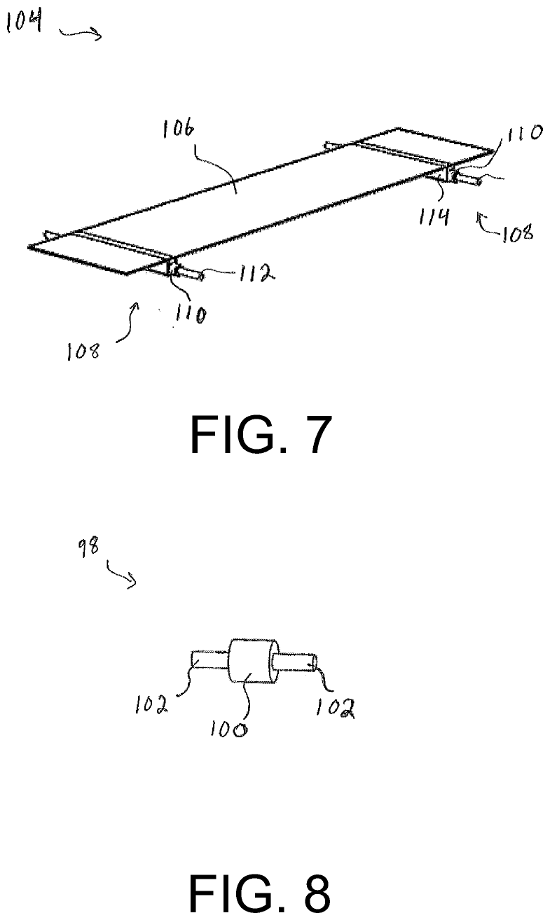

Referring to FIG. 7, an intermediate panel assembly 104 is configured to couple to a lateral side of guard 50. When intermediate panel assembly 104 is coupled to guard 50, a larger area is protected from falling objects. Intermediate panel assembly 104 may further couple to another guard 50 in order to protect the area between two guards 50. Intermediate panel assembly 104 can extend across the space between two guards to protect a larger area than a single guard 50.

Intermediate panel assembly 104 generally includes an intermediate panel 106 and two guard connecting bars 108. Intermediate panel 106 is generally rectangular in shape and is similar to upper panels 62 and lower panels 72 of guard 50.

Intermediate panel 106 can be made of a rigid material that resists deformation and resists impacts, for example rolled aluminum. Guard connecting bars 108 are coupled to intermediate panel 106 on opposing ends. Intermediate panel 106 can be coupled to guard connecting bars 108 using one or more screws, bolts, rivets, nails, adhesives, welds, and/or other fasteners. In one embodiment, intermediate panel 106 couples to one or more fastener sheets 114 coupled to guard connecting bars 108.

Guard connecting bars 108 generally include a guard separator 110 and connector pins 112. Connector pins 112 are positioned on the right and left ends of intermediate panel assembly 104. Connector pins 112 couple to pin openings 94 on guard 50. In one embodiment, connector pins 112 are similar in size and shape to height setting pins 92, and pin openings 94 are configured to receive to both connector pins 112 and height setting pins 92. In an alternate embodiment, guard 50 defines separate openings configured to couple to connector pins 112. Guard separator 110 is positioned between connector pins 112 on guard connecting bar 108. When the connector pin 112 is positioned within pin opening 94, guard separator 110 contacts guard 50. When intermediate panel assembly 104 is coupled to a guard 50 on each side, guard separator 110 is positioned between guards 50 and prevents guards 50 from moving towards each other.

Referring to FIG. 8, an intermediate pin 98 is configured to couple two guards 50 together. Intermediate pin 98 generally includes connector pins 102 and a guard separator 100. Connector pins 102 couple to pin openings 94 on guard 50. In one embodiment, connector pins 102 are similar in size and shape to height setting pins 92, and pin openings 94 are configured to couple to both connector pins 102 and height setting pins 92. In an alternate embodiment, guard 50 defines separate openings configured to couple to connector pins 102. Guard separator 100 is positioned between connector pins 102 on guard connecting bar 108. When intermediate pin 98 is coupled to a guard 50 on each side, guard separator 100 is positioned between guards 50 and prevents guards 50 from moving towards each other.

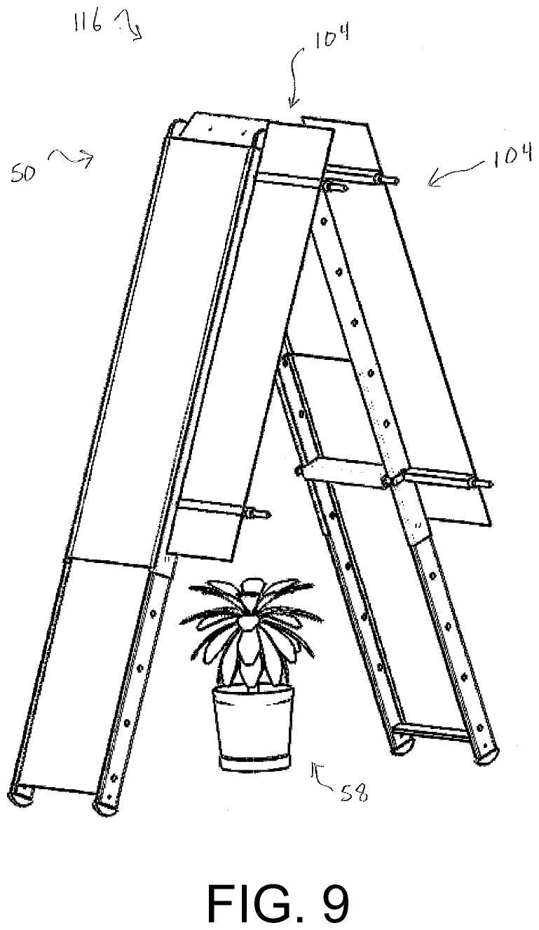

Referring to FIG. 9, guard assembly 116 can be constructed from guard 50 coupled to two intermediate panel assemblies 104. As illustrated, intermediate panel assemblies 104 are coupled to upper panel assemblies 60 and lower panel assemblies 70 of guard 50 on front side 54 and rear side 56. In the illustrated embodiment, the weight of guard 50 is substantial enough such that guard 50 maintains stability when intermediate panel assemblies 104 are coupled to guard 50 on one lateral side. In another embodiment, at least one intermediate panel assembly 104 is coupled to each lateral side of guard 50.

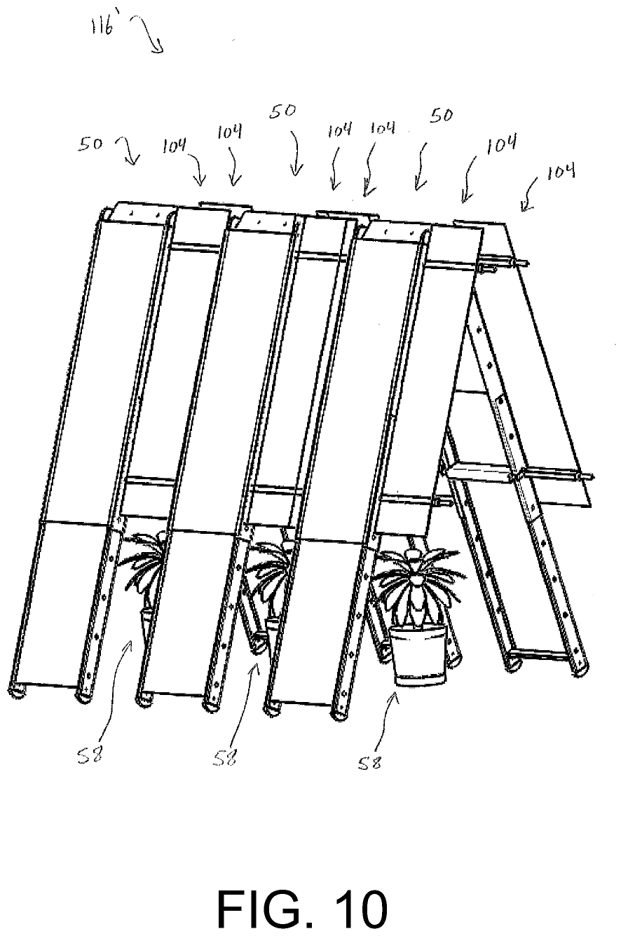

Referring to FIG. 10, another embodiment of guard assembly 116′ can be constructed from multiple guards 50 coupled to multiple intermediate panel assemblies 104. As shown, each intermediate panel assembly 104 is coupled to two guards 50. Additionally, one guard 50 is coupled to two intermediate panel assemblies 104 on each lateral side. Guard assembly 116 can be expanded to include any number of guards 50 and intermediate panel assemblies 104. In one embodiment of guard assembly 116 at least one intermediate panel assembly 104 is coupled between every two guards 50.

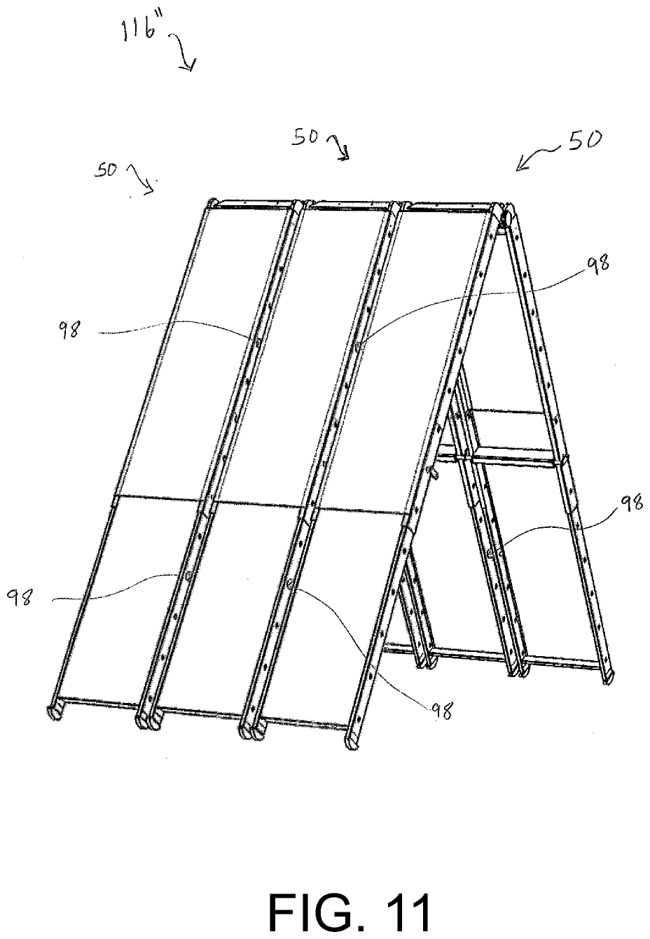

Referring to FIG. 11, yet another embodiment of guard assembly 116″ includes multiple guards 50 coupled to multiple intermediate pins 98. In the shown embodiment, two intermediate pins 98 couple to each pair of guards 50 on each side. Guard assembly 116 can be expanded to include any number of guards 50. In one embodiment, at least one intermediate pin 98 is coupled between every two guards 50 in guard assembly 116″.

Further, guard assembly 116″ can include any number of guards 50 coupled using any combination of intermediate pins 98 and intermediate panel assemblies 104. For example, guard 50 is coupled to one guard 50 using one or more intermediate panel assemblies 104 on one lateral side, and is coupled to another guard 50 using one or more intermediate pins 98 on the other lateral side.

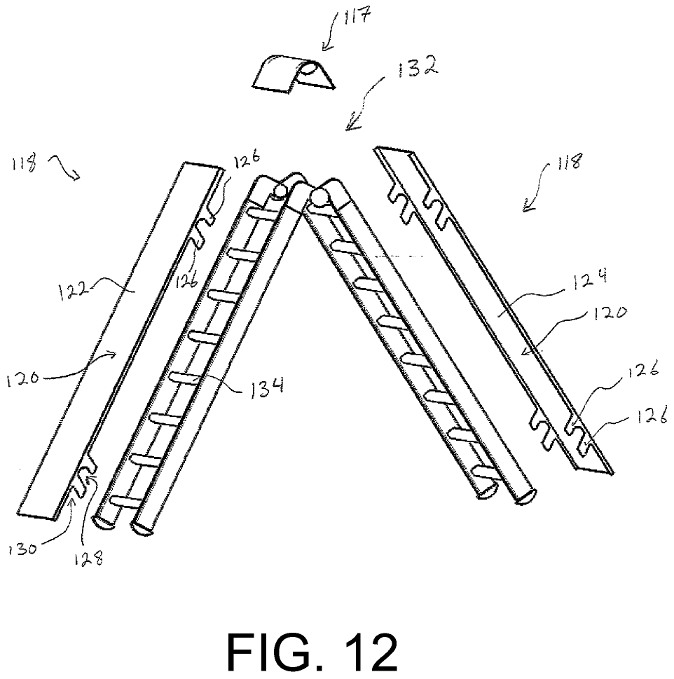

Referring to FIG. 12, hood 117 and barrier accessory 118 can be used to shield one or more objects 58 in a similar way as guard 50. Hood 117 and barrier accessory 118 are configured to couple to ladder 132 on an exterior portion. In the illustrated example, ladder 132 is coupled to barrier accessory 118 on each side and one hood 117 on an upper portion. Hood 117 and barrier accessory 118 may couple to a variety of ladder types. For example, hood 117 and barrier accessory 118 are designed to couple to step ladders, straight ladders, platform ladders, extension ladders, trestle ladders, and/or another type of ladder. The combined ladder 132, hood 117, and barrier accessory 118 are positioned above an object 58 to provide protection in a vertical direction. To withstand impacts and resist deformation, hood 117 and barrier accessory 118 are made of a rigid material. In one embodiment, hood 117 and barrier accessory 118 are made from the same material as guard 50.

Hood 117 is configured to couple to an upper portion of ladder 132, and/or an upper portion of one or more barrier accessories 118. Hood 117 covers a space between the sides of ladder 132 such that object 58 is protected from debris that may fall vertically between barrier accessories 118 on either side of ladder 132. The weight of hood 117 provides a downward force such that hood 117 is coupled against ladder 132 and/or barrier accessories 118.

Barrier accessory 118 generally includes an accessory panel 120 and one or more tabs 126. Accessory panel 120 is generally rectangular in shape and is similar to the front and rear panels of guard 50. The size and shape of accessory panel 120 may be determined based on the size and shape of a particular ladder 132. Accessory panel 120 includes panel front side 122 and panel rear side 124. Panel rear side 124 faces ladder 132 when barrier accessory 118 is attached. Panel front side 122 faces outwards to contact any falling objects.

Tabs 126 of barrier accessory 118 are positioned on panel rear side 124 and extend away from accessory panel 120. Tabs 126 contact one or more ladder rungs 124 when barrier accessory 118 is coupled to ladder 132. The weight of barrier accessory 118 provides a downward force through tabs 126 such that barrier accessory 118 is coupled against ladder 132. In one embodiment, tabs 126 are angled in a downward direction to conform to a portion of a surface of the ladder rungs 124.

In one embodiment, tabs 126 are positioned in pairs. When tabs 126 are arranged in pairs, one tab 126 is positioned above another tab 126. Two tabs 126 define an inter-tab space 128. The two tabs 126 are positioned such that ladder rung 134 can be positioned in inter-tab space 128. Additionally, tab 126 and panel rear side 124 define sub-tab space 130. The ladder rungs 124 may be positioned in either inter-tab spaces 128 or sub-tab spaces 130. In one embodiment, one or more ladder rungs 124 are positioned in inter-tab spaces 128 and one or more ladder rungs 124 are positioned in sub-tab spaces 130. Further, tabs 126 may be placed at various points along the width of accessory panel 120. In one embodiment, one tab 126 is positioned on the right end and one tab 126 is positioned on the left end of accessory panel 120. In an alternate embodiment, one or more tabs 126 extend between the right and left ends of accessory panel 120.

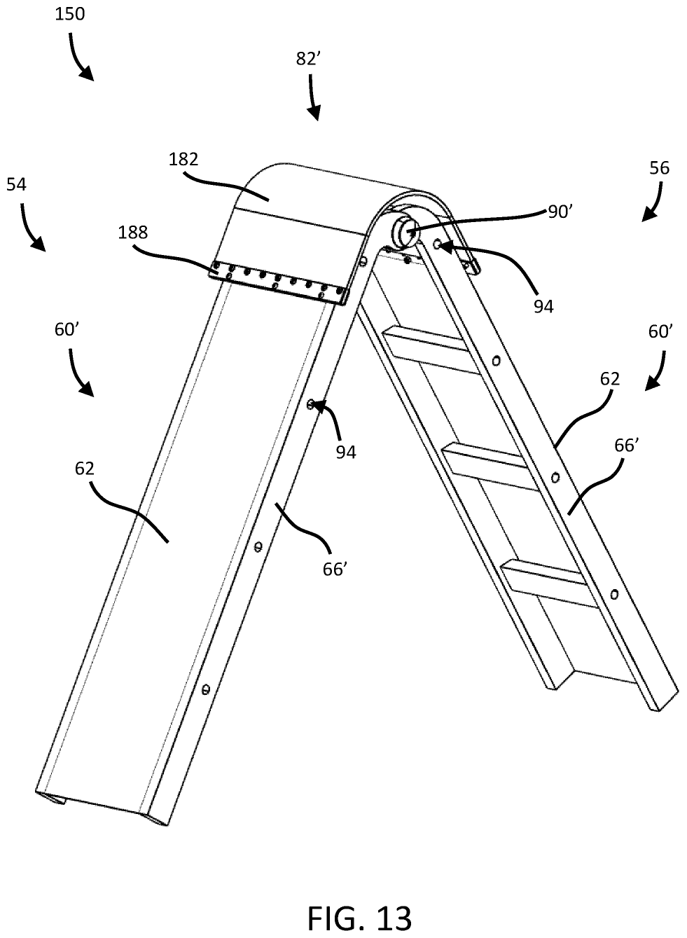

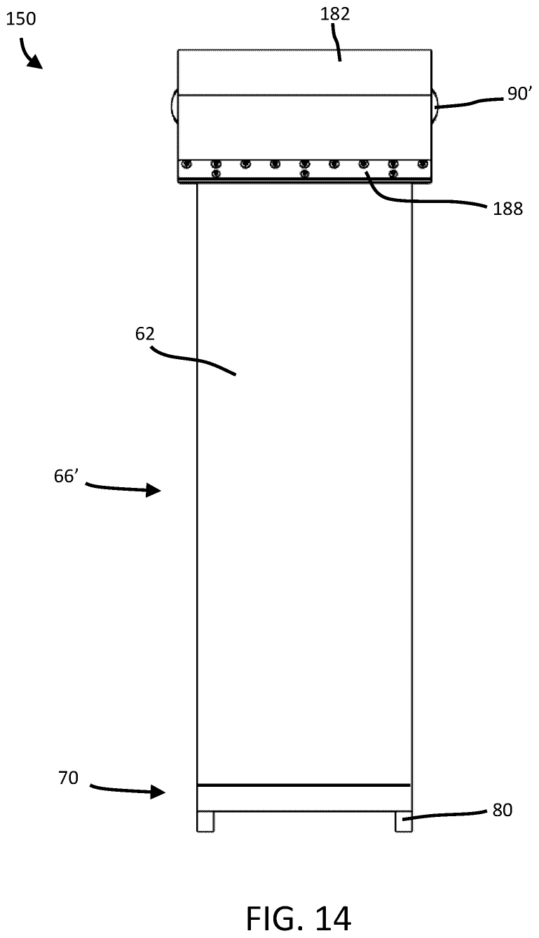

FIGS. 13 and 14 illustrate guard 150, an alternative embodiment of a guard that incorporates some features of guard 50 illustrated in previous figures. As shown, guard 150 can include upper panel assemblies 60′, hinges 90′, and/or other components from guard 50. Guard 150 can further include other components as described in the other examples of guard 50, such as lower panel assemblies 70, feet 80, height setting pins 90, and/or other components. Further, guard 150 is generally configured to protect objects 58 in a similar way and/or to be adjustable in a similar way as guard 50. For example, panel assembly 60′ on front side 54 is generally rotatable relative to panel assembly 60′ on rear side 56 via hinges 90′. As another example, lower panel assemblies 70, as shown in FIG. 1, can nest partially within and/or can be movably coupled to upper panel assemblies 60′ to allow the overall height of guard 150 to be adjusted. Guard 150 can further define pin openings 94 on upper legs 66′ and/or lower legs 76 (not pictured). Pins 92 can be selectively coupled to one or more pin openings 94 to selectively fix the relative position of upper panel assembly 60′ to lower panel assembly 70. As should be appreciated, guard 150 can include any combination of components and/or the components of guard 150 can interact in the same or similar ways as described for the examples of guard 50 described previously.

As illustrated, guard 150 can further include top plate 82′. Top plate 82′ generally covers a gap between upper panel assemblies 60 on the terminal ends on the top side between panels 62. In the FIG. 13 example, top plate 82′ can be in the form of flexible sheet 182. Sheet 182 provides full coverage (from above) across the gap between panel assemblies 60′ regardless of the orientation of panel assemblies 60′. For example, the size of the gap can change as panel assemblies 60′ are rotated relative to one another. Sheet 182 can flex (to account for movement of the panel assemblies it is coupled to) to cover the gap through the full range of rotation between panel assemblies 60′. In other words, when viewed from above, sheet 182 can fully cover the gap regardless of the relative orientation between panel assemblies 60′. In one example, sheet 182 can be a continuous piece of material. In another example, sheet 182 can include multiple links and/or panels that collectively allow sheet 182 to bend at discrete points. Additionally, because sheet 182 is flexible, sheet 182 can temporarily deform during an impact from a falling object so as to absorb energy from and slow down the falling object.

Guard 150 can optionally include fastener strip 188 to help secure sheet 182 to guard 150. Fastener strip 188 can be made of a rigid material, such as steel or another metal. Fastener strip 188 can provide rigid support for sheet 182 at the point that sheet 182 attaches to guard 150. For example, fastener strip 184 can provide a uniform and rigid surface for bolts, screws, rivets, and/or other fasteners to hold against so as to secure sheet 182 to guard 150. In that example, fastener strip 188 can define holes to receive the fasteners. Guard 150 can similarly define holes in corresponding locations to receive the fasteners. In another example, fastener strip 188 can directly secure sheet 182 to guard 150 and/or can help attach sheet 182 to guard 150 in another way. In the illustrated example, one fastener strip 188 can help secure sheet 182 to panel assembly 60 on front side 54 and another fastener strip 188 can help secure sheet 182 to panel assembly 60 on rear side 56. Further, an additional fastener strip 188 can be positioned between sheet 182 and panel assembly 60′ on each of front side 54 and rear side 56. As should be appreciated, any number and/or arrangement of fastener strips 188 can be used to attach sheet 182 to guard 150 across the gap.

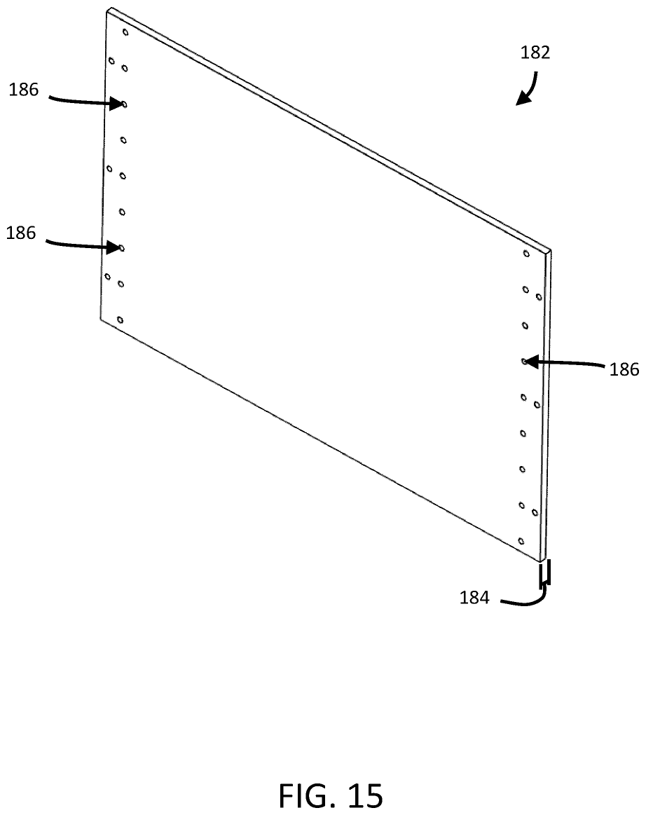

Referring to FIG. 15, sheet 182 can generally be rectangular in shape. Sheet 182 can be sized to extend fully across a width of panel assemblies 60′ in one dimension and fully across the gap between panel assemblies 60′ in another dimension. Sheet 182 can be formed by cutting sheet 182 from a larger body of material, by molding, and/or through another process. Further, sheet 182 can be made of a flexible yet durable material, such as rubber. In one example, sheet 182 can be made of a styrene-butadiene rubber (SBR). Sheet 182 can generally have high abrasion resistance and aging stability. Such characteristics can allow sheet 182 to withstand a large amount of flexing over a long period of time. In one example, sheet 182 is configured to withstand large impacts, such as the impact of a 240-pound object falling from twenty feet above guard 150, without tearing and/or breaking in another way. Sheet 182 can further be reinforced with additional materials, such as strands and/or sheets of fabric, polymers, and/or other materials. For instance, sheet 182 can include multiple layers of rubber that sandwich one or more layers of nylon, polyamide, and/or another material. As shown, sheet 182 defines thickness 184. Thickness 184 can be at least one eighth of an inch, three sixteenths of an inch, half of an inch, and/or another amount. Such thickness 184 can ensure that sheet 182 is durable and configured to withstand large impacts.

As shown, sheet 182 can optionally define multiple fastener holes 186. Fastener holes 186 can receive screws, bolts, rivets, and/or other types of fasteners to secure sheet 182 to panel assemblies 60′. The positions of fastener holes 186 can generally align with holes on fastener strip 188 and/or panel assemblies 60′ that can also receive fasteners (if used). In one example, sheet 182 is configured to hold fasteners in fastener holes 186 without tearing and/or failing in another way. Fastener holes 188 can be formed by punching material out of sheet 182, such as using a specialized punch tool. In one example, fastener holes 188 can have a diameter of one quarter of an inch.

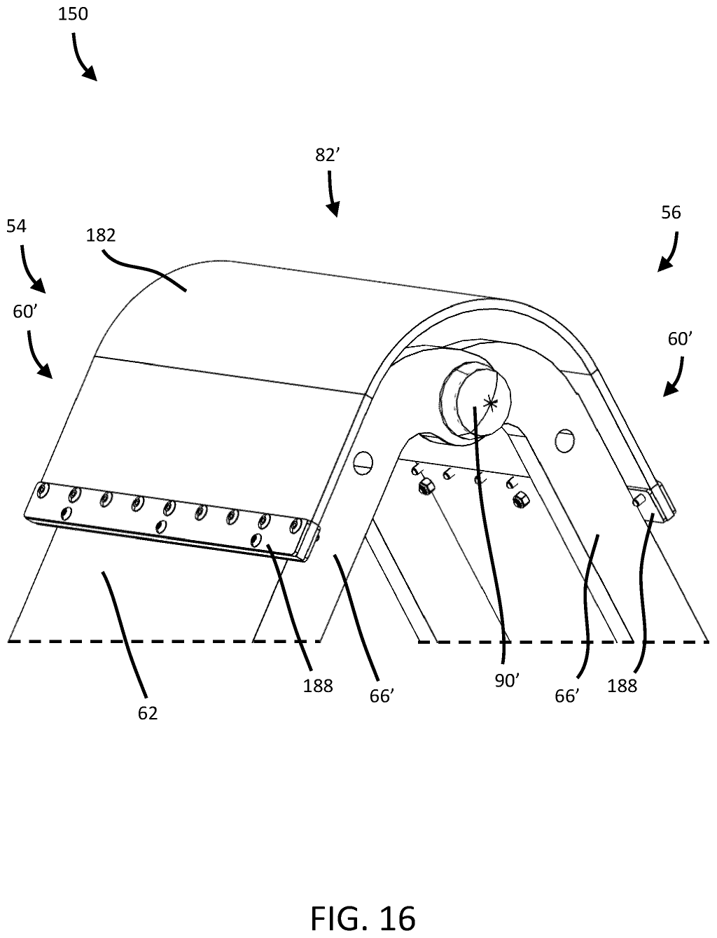

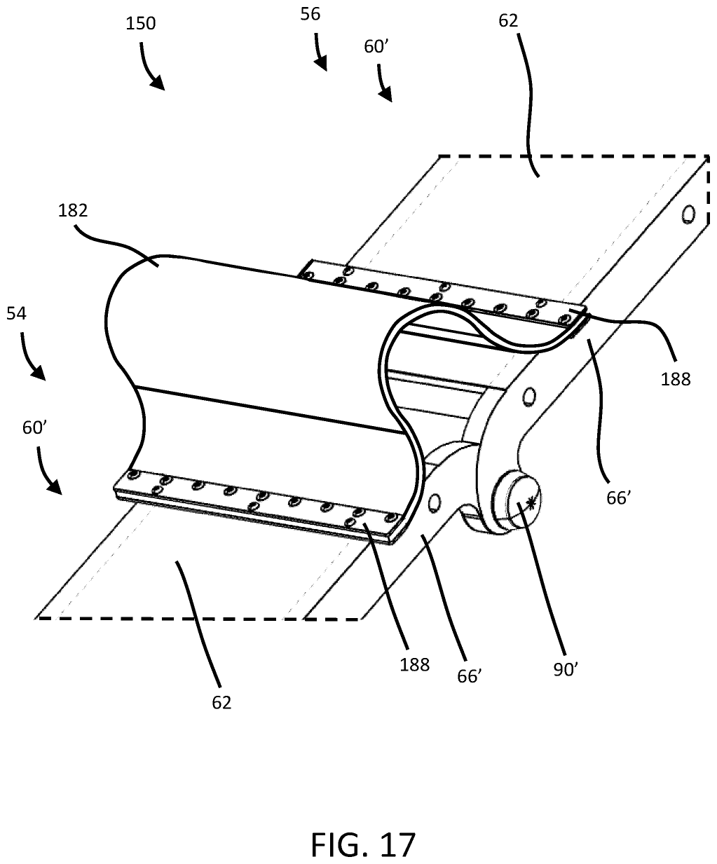

FIGS. 16 and 17 illustrate sheet 182 when guard 150 is in a mostly closed configuration and in an open configuration. As noted, sheet 182 can flex to allow for consistent coverage over the gap between panel assemblies 60′. When guard 150 is in a closed configuration, sheet 182 can generally conform around the profile of upper legs 66′. In the illustrated example, upper legs 66′ can have a curved shape on the terminal end on the top side. Upper legs 66′ on front side 54 can curve toward rear side 56, and upper legs 66′ on rear side 56 can curve toward front side 54, such that upper legs 66′ on either side curve to meet at hinges 90′. For instance, when guard 150 is fully closed, the terminal end of upper legs 66′ on front side 54 and rear side 56 can form a semi-circular arc along the top side. In one example, sheet 182 can contact upper legs 66′ along the full arc along the top side when guard 150 is fully closed. In the slightly open configuration shown in FIG. 16, sheet 182 can flex and separate partially from upper legs 66′. In this example, sheet 182 can curve along an arc that roughly approximates the terminal end of upper legs 66′.

When guard 150 is fully open, as shown in FIG. 17, sheet 182 can flex further outward from upper legs 66′ and hinges 90′. Sheet 182 is configured to shield objects 58 from above and to cover the gap in both open and closed positions. By securing sheet 182 to panel assemblies 60′, sheet 182 can remain aligned with panel assemblies 60′ throughout the full range of rotation between the open and closed positions. Therefore, throughout the full range of rotation of guard 150, sheet 182 can provide vertical coverage over the gap between panel assemblies 60′. Further, by attaching sheet 182 along panel assemblies 60′ on front side 54 and rear side 56, upper panels 62 can generally transition smoothly into sheet 182. The relatively smooth overall shape of panel assemblies 60′ and sheet 182 can redirect debris and other falling objects off of guard 150 and discourage such objects from catching and/or piling onto guard 150.

While the present disclosure has been illustrated and described in detail in the drawings and foregoing description, the same is to be considered as illustrative and not restrictive in character, it being understood that a preferred embodiment has been shown and described and that all changes, equivalents, and modifications that come within the spirit of the claimed invention defined by following claims are desired to be protected. All publications, patents, and patent applications cited in this specification are herein incorporated by reference as if each individual publication, patent, or patent application were specifically and individually indicated to be incorporated by reference and set forth in its entirety herein.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Merriam-Webster dictionary.

I claim:

1. A guard for protecting an object, wherein the guard is configured to be positioned above the object, the guard comprising:
a front panel assembly comprising a right front leg, a left front leg and a front panel that extends between the right and left front legs from a top terminal end of the right and left front legs, wherein the right front leg defines a front leg length and wherein a length of the front panel is at least half the front leg length;
a rear panel assembly comprising a right rear leg, a left rear leg and a rear panel that extends between the right and left rear legs from a top terminal end of the right and left rear legs, wherein a length of the rear panel is at least equal to the length of the front panel;
a top panel that covers a gap between the front panel assembly and the rear panel assembly, wherein the top panel completely overlies the gap when viewed from above the top panel;
a hinge pin that rotatably couples the front panel assembly and the rear panel assembly about an axis of rotation, wherein the front panel assembly is selectively rotatable about the hinge pin and the rear panel assembly is selectively rotatable about the hinge pin, wherein the front panel assembly and the rear panel assembly are rotatable between an angle of rotation between approximately 0 degrees to at least 45 degrees; and
wherein the guard is adapted to protect the object from a falling mass that is at least 240 pounds failing from 20 feet directly above the object.

2. The guard of claim 1, further comprising:
a second front panel assembly comprising a second right front leg, a second left front leg and a second front panel, wherein the second front panel assembly is nested under the front panel assembly and is selectively movable relative to the front panel assembly to effectively extend the length of the front panel with second front panel.

3. The guard of claim 2, wherein the second front panel assembly is adapted to be fully nested under the front panel assembly.

4. The guard of claim 3, wherein the second front panel is the same length as the front panel and is selectively movable to almost double the effective length of the front panel when fully extended.

5. The guard of claim 2, further comprising:
a height setting pin adapted to selectively extend through a first opening in the right front leg and a second first opening in the second right front leg to selectively fix the position of the second right front leg relative to the right front leg.

6. The guard of claim 5, wherein the right front leg defines a plurality of openings permitting the second right front leg to be secured relative to the right front leg in a plurality of positions thereby defining a plurality of effective lengths of the front panel.

7. The guard of claim 6, a pin receptacle coupled to the front panel assembly, wherein the height setting pin is movably coupled to the pin receptable.

8. The guard of claim 1, wherein the front panel assembly is monolithic in construction.

9. The guard of claim 8, wherein the rear panel assembly is monolithic in construction.

10. The guard of claim 1, wherein the front panel assembly is constructed from rolled aluminum.

11. The guard of claim 1, wherein the guard is adapted to be stored and transported similar to a ladder in a folded configuration.

12. The guard of claim 1, wherein the front panel assembly and the rear panel assembly are rotatable between the angle of rotation between approximately 0 degrees up to 180 degrees.

13. The guard of claim 1, wherein the top panel is selectively rotatable relative to both the front panel assembly and the rear panel assembly.

14. The guard of claim 1, wherein the hinge pin rotatably couples the top panel about the axis of rotation.

15. The guard of claim 1, wherein the top panel is a flexible sheet with a first end fixedly coupled to the front panel assembly and a second end fixedly coupled to the rear panel assembly.

16. The guard of claim 15, further comprising a plurality of fastener strips that couple the flexible sheet to the front panel assembly and the rear panel assembly.

17. The guard of claim 15, wherein the flexible sheet completely fills the gap between the front panel assembly and the rear panel assembly.

18. The guard of claim 1, wherein the front panel extends down from the top terminal end of the right and left front legs a majority of the front leg height and wherein the rear panel extends down from the top terminal end of the right and left front legs a majority of the rear leg height.

19. A guard assembly comprising:
a first guard according to claim 1, wherein the right front leg of the front panel assembly defines a plurality of coupling apertures;
a second guard according to claim 1, wherein the left front leg of the front panel assembly defines a plurality of coupling apertures;
a plurality of coupling pins positioned in the plurality of coupling apertures in the first and second guards to couple the right front leg of the first guard to the left front leg of the second guard.

20. A guard assembly comprising:
a first guard according to claim 1, wherein the right front leg of the front panel assembly defines a plurality of coupling apertures;
a second guard according to claim 1, wherein the left front leg of the front panel assembly defines a plurality of coupling apertures;
an intermediate panel assembly comprising an upper connector bar, a lower connector bar and an intermediate panel extending between the upper and lower connector bars, wherein the upper and lower connector bars are positioned in the plurality of coupling apertures in the first and second guards to couple the right front leg of the first guard to the left front leg of the second guard while covering a gap between adjacent front panels with the intermediate panel.
